(19) United States
(12) Patent Application Publication
(10) Pub. No.: US 2022/0018313 A1
(43) Pub. Date: Jan. 20, 2022

(54) IN-SPACE PROPULSION SYSTEM

(71) Applicant: Hieu Do, Round Rock, TX (US)

(72) Inventor: Hieu Do, Round Rock, TX (US)

(21) Appl. No.: 16/732,988

(22) Filed: Jan. 2, 2020

(51) Int. Cl. F02K 9/46; F02K 9/60

(52) U.S. Cl. CPC F02K 9/46; F02K 9/605; F05D 2260/601; F05D 2260/213; F05D 2260/207

(57) ABSTRACT

Apparatus and associated methods relate to an in-space propulsion system configured to generate propulsion from a recirculated working fluid. In an illustrative example, the propulsion system may include a boiler configured to generate high pressure gas from the working fluid. The gas may, for example, be ejected from a nozzle into a distributor tube. A radiator coupled to the distributor tube may, for example, facilitate phase transition of the gas back into the working fluid. The fluid may be collected via one or more collection ducts coupled to the radiator. One or more pumps may recirculate the working fluid from the one or more collection ducts back into the boiler. Various embodiments may advantageously recirculate the working fluid such that propulsion is generated in response to an external power source while substantially an entire mass of the working fluid is preserved in the propulsion system.

### RELATED APPLICATION

This application incorporates in its entirety, and hereby claims priority to, application 62/827,785 filed Apr. 1, 2019, titled “IN-SPACE PROPULSION SYSTEM”.

### BACKGROUND

### 1. Technical Field

Embodiments of the invention disclosed generally relate to systems and associated methods for in-space spacecraft propulsion.

### 2. Description of the Related Art

Generally known technology for in-space propulsion of spacecraft is based on ejection of a propellant from the spacecraft.

Systems for spacecraft propulsion that do not eject mass from the spacecraft have been proposed. See, for example, “DiscThruster, A Pressure Thrust Based Aircraft, Launch Vehicle and Spacecraft Engine” (WO 2016/153577 A2), and “Method and Apparatus for Generating Propulsive Forces Without Ejection of Propellant” (U.S. Pat. No. 6,347,766 B1).

### SUMMARY OF ILLUSTRATIVE EMBODIMENTS

Disclosed are systems and methods for in-space propulsion of a spacecraft.

In one aspect, the invention is directed to a method of in-space propulsion. The method includes the steps of providing a power source to boil a working fluid in a boiler chamber into a gaseous propellant; ejecting the propellant out of a conical nozzle; collecting the propellant in a radiator and cooling it to condensation; and pumping the propellant back to the boiler chamber. This method is primarily, if not entirely, accomplished inside a closed loop system that recirculates and preserves the working fluid.

Another aspect of the invention concerns a propulsion system. The propulsion system includes a power source coupled to a boiler chamber. A conical nozzle, capable of producing a jet of gaseous fluid, is coupled to the boiler chamber for ejecting the working fluid out of the boiler chamber and into a radiator. The radiator is configured to cool and condensate the working fluid. Through induced rotation of the propulsion system, or rotation of at least some of the radiator components, the working fluid is collected by collection ducts. The propulsion system includes pumps to move the working fluid from the collection ducts back to the boiler chamber.

The above as well as additional features and advantages of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is an elevation view of a propulsion system embodying aspects of the disclosed inventions.

FIG. 2 is an elevation view of a second embodiment of a propulsion system in accordance with inventive features described herein.

FIG. 3 is a top plan view of the system of FIG. 2.

FIG. 4 is a side plan view of the system of FIG. 2.

FIG. 5 is a detail view of various components of the system of FIG. 2.

FIG. 6 is yet another detail view of various components of the system of FIG. 2.

FIG. 7 is yet another detail view of various components of the system of FIG. 2.

### DETAILED DESCRIPTION OF ILLUSTRATIVE EMBODIMENTS

In the following detailed description of exemplary embodiments of the invention, specific exemplary embodiments in which the invention may be practiced are described in sufficient detail to enable those skilled in the relevant technology to practice the invention, and it is to be understood that other embodiments may be used and that logical, architectural, programmatic, mechanical, electrical and other changes may be made without departing from the spirit or scope of the present invention.

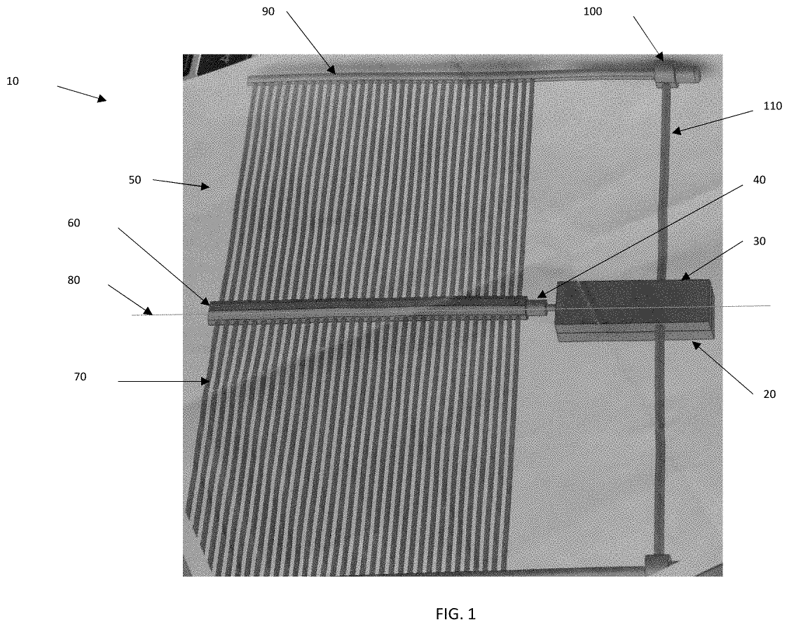

Referencing FIG. 1, in one embodiment a propulsion system 10 includes a heating source 20 configured to boil a liquid to create a gaseous working fluid in a boiler chamber 30. The power source 20 can be, for example, a nuclear reactor or an electric motor powered by a photovoltaic array that receives star light. The boiler chamber 30 can be any well known configuration of containers for holding pressurized fluids or gases.

The boiler chamber 30 is coupled to a conical nozzle (not shown in FIG. 1) that is received in a coupler body 40. The conical nozzle is configured, according to well understood principles, to produce a jet of gaseous steam exiting the boiler chamber 30. The working fluid ejected from the boiler chamber 30 via the conical nozzle enters a radiator 50, which radiator 50 is configured to allow cooling of the working gaseous fluid as it is distributed via a distributor tube 60 to an array of cooling ducts 70.

The propulsion system 10 spins about a central axis 80. The spin can be induced under gravitational forces, gyroscopic forces, or on-board actuators, for example. The spinning of the propulsion system 10 causes the cooling, condensing working fluid to be collected by collection ducts 90. A pump 100 at a distal end of each of the collection ducts 90 pumps the working fluid back into the boiler chamber 30 via return ducts 110. In this manner, the propulsion system 10 recirculates the working fluid.

Propulsion is provided by propulsion system 10 in the following manner. The gaseous jet exiting the conical nozzle imparts a momentum thrust to the boiler chamber 30. As the gaseous working fluid is cooled in the radiator 50 it loses linear momentum. The differential in linear momentum provides the momentum thrust that propels the boiler chamber 30. In one embodiment, additional mechanisms (such as pumps) create suction forces that deflect the working fluid from its linear flow along the central axis 80, which deflection changes the momentum vector of the working fluid toward the direction of the collection ducts 90. This deflection results in a liner momentum differential that propels the boiler chamber 30 in a direction opposite the jet flow of the working fluid out of the conical nozzle.

Although the propulsion system 10 recirculates the working fluid, the propulsion system 10 operates consistently with the principle of conservation of momentum. This is true because the closed system is the boiler chamber 30, the associated conical nozzle, radiator 50, collection ducts 90, and return ducts 110. The closed system is acted upon by the external energy source provided by the heating source 20. Eventually, if the heating source 20 were allowed to be turned off or completed depleted, then the propulsion system 10 would come to a stop.

As one principle of operation of the propulsion system 10, it is proposed that particles of the working fluid lose kinetic energy, and hence momentum, as the working fluid travels in the distributor tube 60 and cooling ducts 70. The particles of the working fluid will in the aggregate experience many inelastic collisions. Inelastic collisions cause the particles to lose momentum. Hence, when the particles eventually strike the walls of the radiator in an axis along (or parallel to) the central axis 80, the particles would have lost linear momentum in that direction, which then results in a momentum differential of the working fluid from the conical nozzle down to the various cooling ducts 70. Depending on the geometry of the propulsion system 10, with regards to size and, for example, the curvature (if any) of the cooling ducts 70, the momentum differential may be quite small. Nevertheless, small differentials in momentum will add up over every cycle of recirculation of the working fluid. Given the environment of in-space travel (assuming very low gravitational forces in effect), then it can be seen that the propulsion system will gain significant speed after a period of operation.

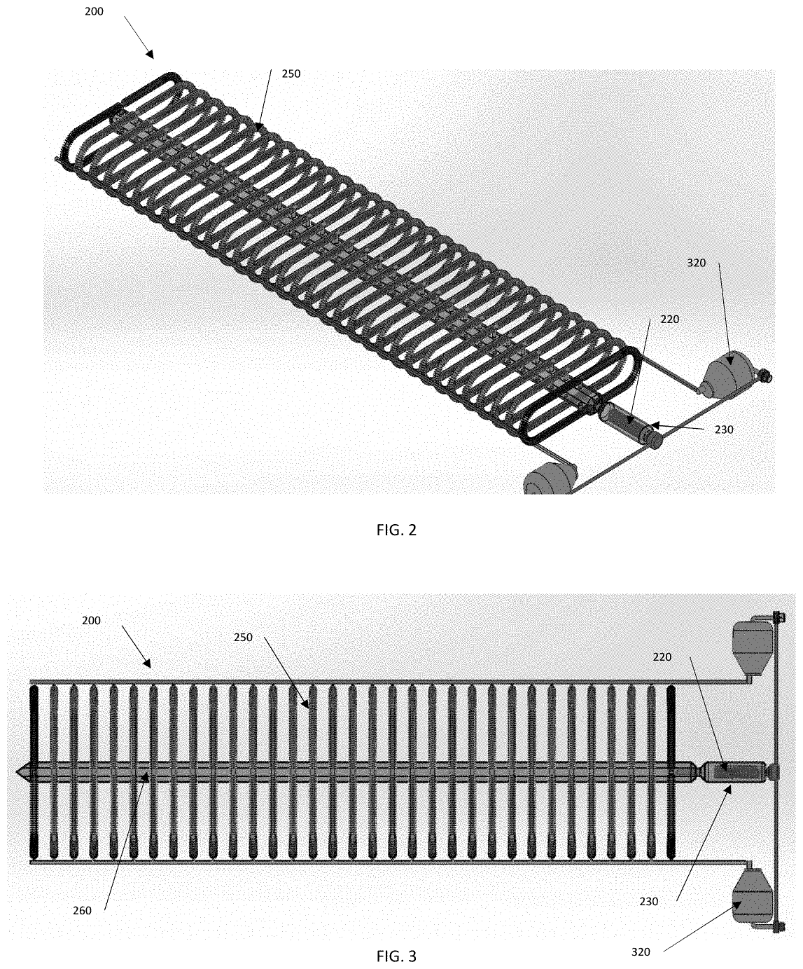

Referencing FIG. 2 and FIG. 3, one embodiment of a propulsion system 200 is shown and described as follows. Propulsion system 200 includes a power source 220 configured to boil a liquid to produce a gaseous working fluid in a boiler chamber 230.

The boiler chamber 230 is coupled to a conical nozzle 240 (see FIG. 7). The conical nozzle 240 is configured to produce a jet of gaseous steam exiting the boiler chamber 230. The working fluid ejected from the boiler chamber 230 via the conical nozzle 240 enters a radiator 250, which radiator 250 is configured to allow cooling of the working gaseous fluid as it is distributed via a distributor tube 260 (See FIG. 5) to an array of cooling ducts 270 (See FIG. 5). The cooling ducts 270 are provided with cooling fins.

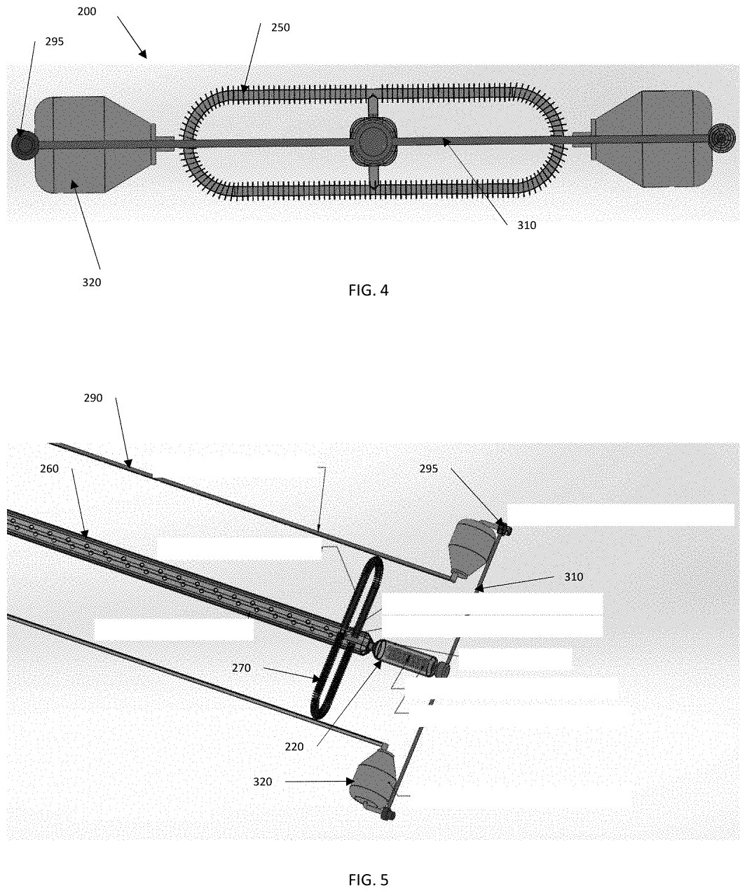

The cooling, condensing working fluid is collected by collection ducts 290. A pump 295 at a distal end of each of the collection ducts 290 pumps the working fluid back into the boiler chamber 230 via return ducts 310 (see FIG. 4 and FIG. 5). In this manner, the propulsion system 200 recirculates the working fluid.

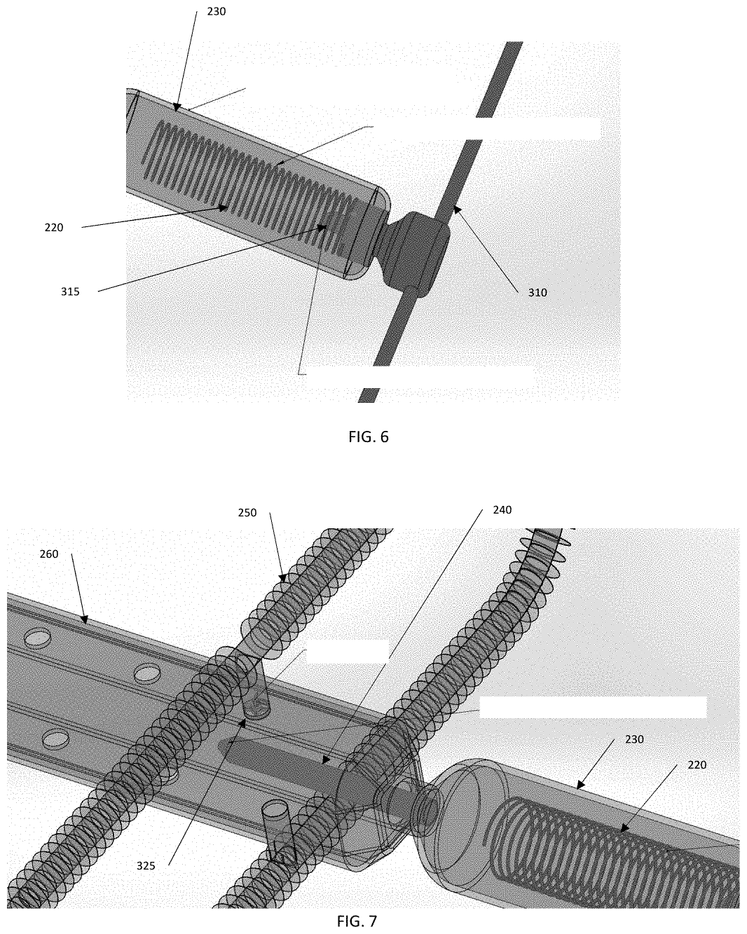

Referencing FIG. 5, in one embodiment, the system 200 includes one or more storage tanks 320 coupled to the collection ducts 290 and the pump 295. Referencing FIG. 6, a high pressure water jet spray nozzle 315 is coupled to the return ducts 310. Referencing FIG. 7, one or more fans 325 are provided to move the hot steam from the distributor tube 260 into the radiator 250.

In operation, the working fluid (water, for example) is boiled in the boiler 230 to a working gas (steam, for example) at high pressure. The highly pressurized working gas is then ejected into the distributor tube 260 via the conical nozzle 240. The ejected working gas then transfers momentum to the propulsion system 200, having the effect of displacing the propulsion system in the direction opposite to the ejection of the working gas. The pressure of the pressurized gas drops as it expands into the distributor tube 260. The working gas is then moved from the distributor tube 260 into the cooling ducts 270 of radiator 250 by fans 325. As the gas cools into a liquid, via heat transfer from the fins of the cooling ducts 270 with the external environment of space, then it is delivered to collection ducts 290. In one embodiment, the movement of the cooled liquid into the collection ducts 290 might be aided through spinning of propulsion system 200 about an axis central and along the distributor tube 260. The collection ducts 290 then deliver the working fluid to the storage tanks 320. The pumps 295 then drive the working fluid into the boiler chamber 230 via the return ducts 310. In this manner the working fluid is recirculated without being ejected into space. The power source 220 can be, for example, a thermo-nuclear power plant.

While the invention has been described with reference to exemplary embodiments, it will be understood by those skilled in the relevant technology that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention.

What is claimed is:

1. An in-space propulsion system comprising:
a power source and a boiler configured to generate from a working fluid a gas at high pressure;
a nozzle to deliver the gas into a distributor tube, the distributor tube allowing expansion of the gas such that the pressure of the gas drops after being ejected from the nozzle;
a radiator coupled to the distributor tube, the radiator configured to facilitate the cooling of the gas back into the working fluid;
one or more collection ducts coupled to the radiator and configured to receive the working fluid produced from the gas;
one or more pumps to move the working fluid from the one or more collection ducts back into the boiler; and
wherein the working fluid and the gas are substantively recirculated in the propulsion system such that substantively no mass from the fluid and gas is ejected into space.

2. The propulsion system of claim 1, further comprising one or more storage tanks for receiving the working fluid from the collections ducts, and wherein the storage tanks are coupled to pumps.

3. The propulsion system of claim 1, further comprising fins for radiating heat from the gas into space, the fins coupled to the radiator.

4. The propulsion system of claim 1, further comprising one or more return ducts for delivering the working fluid from the pumps to the boiler, the return ducts coupled to the pumps and the boiler.

5. The propulsion system of claim 1, further comprising fans for moving the gas from the distributor tube into the radiator.

6. The propulsion system of claim 1, wherein the radiator comprises one or more cooling ducts, and wherein in the cooling ducts are coupled to fins.

7. A method for providing in-space propulsion, the method comprising:
providing a power source and a boiler configured to generate from a working fluid a gas at high pressure;
providing a nozzle configured to deliver the gas into a distributor tube, the distributor tube allowing expansion of the gas such that the pressure of the gas drops after being ejected from the nozzle;
providing a radiator coupled to the distributor tube, the radiator configured to facilitate the cooling of the gas back into the working fluid;
providing one or more collection ducts coupled to the radiator and configured to receive the working fluid produced from the gas;
providing one or more pumps to move the working fluid from the one or more collection ducts back into the boiler; and
recirculating the working fluid and the gas in the propulsion system such that substantively no mass from the fluid and gas is ejected into space.

8. The method of claim 7, further comprising providing one or more storage tanks for receiving the working fluid from the collections ducts, and wherein the storage tanks are coupled to pumps.

9. The method of claim 7, further comprising providing fins for radiating heat from the gas into space, the fins coupled to the radiator.

10. The method of claim 7, further comprising providing one or more return ducts for delivering the working fluid from the pumps to the boiler, the return ducts coupled to the pumps and the boiler.

11. The method of claim 7, further comprising providing fans for moving the gas from the distributor tube into the radiator.

12. The method of claim 7, wherein providing a radiator comprises providing one or more cooling ducts, and wherein in the cooling ducts are coupled to fins.

13. A method for providing in-space propulsion, the method comprising:
generating from a working fluid a gas at high pressure;
allowing expansion of the gas such that the pressure of the gas drops after being ejected from a nozzle;
cooling the gas back into the working fluid; and
recirculating the working fluid and the gas such that substantively no mass from the fluid and gas is ejected into space.

14. The method of claim 13, further comprising storing the working fluid in storage tanks.

15. The method of claim 13, further comprising radiating heat from the gas into space.

16. The method of claim 13, wherein recirculating the working fluid further comprises pumping the working fluid.
